(19) United States
(12) Patent Application Publication
(10) Pub. No.: US 2016/0342042 A1
(43) Pub. Date: Nov. 24, 2016

(54) PIXEL STRUCTURE AND LIQUID CRYSTAL DISPLAY PANEL COMPRISING SAME

(71) Applicant: Shenzhen China Star Optoelectronics Technology Co., Ltd., Shenzhen, Guangdong (CN)

(72) Inventors: Chengzhong YU, Shenzhen, Guangdong (CN); Yahui CHEN, Shenzhen, Guangdong (CN); Hsiaohsien CHEN, Shenzhen, Guangdong (CN); Yungjui LEE, Shenzhen, Guangdong (CN)

(73) Assignee: Shenzhen China Star Optoelectronics Technology Co. Ltd., Shenzhen, Guangdong (CN)

(21) Appl. No.: 14/428,638

(22) PCT Filed: Feb. 6, 2015
(86) PCT No.: PCT/CN2015/072364

§ 371 Date: Mar. 16, 2015

(30) Foreign Application Priority Data
Nov. 5, 2014 (CN) 201410619220.2

(51) Int. Cl. G02F 1/1343; G02F 1/1335; G02F 1/1362; G02F 1/1368

(52) U.S. Cl. CPC G02F 1/134336; G02F 1/1368; G02F 1/133514; G02F 1/133512; G02F 1/136286; G02F 1/13624

(57) ABSTRACT

The present invention provides a pixel structure and a liquid crystal display panel including the pixel structure. The pixel structure includes a plurality of pixel units (1) arranged in an array. Each of the pixel units (1) includes a red sub-pixel (11), a green sub-pixel (12), and a blue sub-pixel (13) that are arranged in the form of a window sash. The red sub-pixel (11) and the blue sub-pixel (13) are arranged in a row in a vertical direction. The green sub-pixel (12) is individually arranged in a row. A surface area of the green sub-pixel (12) is greater than or equal to the sum of surface areas of the red sub-pixel (11) and the blue sub-pixel (13). A black matrix (4) is arranged along outer circumferences of the red sub-pixel (11), the green sub-pixel (12), and the blue sub-pixel (13). The pixel structure reduces the area occupied by the black matrix (4), expands the surface area of the green sub-pixel (12), increases aperture ratio and light transmittance, and enhances displaying performance.

### BACKGROUND OF THE INVENTION

1. Field of the Invention

The present invention relates to the field of display technology, and in particular to a pixel structure and a liquid crystal display device comprising the pixel structure.

2. The Related Arts

Liquid crystal displays (LCDs) have a variety of advantages, such as thin device body, low power consumption, and being free of radiation, and are thus of wide applications, such as liquid crystal televisions, mobile phones, personal digital assistants (PDAs), digital cameras, computer monitors, and notebook computer screens, so as to take a leading position in the field of flat panel displays.

Most of the liquid crystal displays that are currently available are backlighting liquid crystal displays, which comprise an enclosure, a liquid crystal display panel arranged in the enclosure, and a backlight module mounted in the enclosure. The liquid crystal panel is a major component of a liquid crystal display; however, the liquid crystal display panel itself does not emit light and light must be supplied from the backlight module in order to normally display images.

A mainstream of the liquid crystal display panels is one comprising a thin-film transistor (TFT) array substrate and a color filter (CF) substrate laminated together with liquid crystal filled between the TFT substrate and the CF substrate. Application of electricity controls the liquid crystal molecules to change direction so as to refract light from the backlight module to generate an image.

In such a structure, the CF substrate comprises, on one surface thereof, a plurality of pixels units arranged in an array. Each of the pixel units comprises a red sub-pixel, a green sub-pixel, and a blue sub-pixel. A black matrix (BM) is arranged to surround an outer circumference of each of the sub-pixels for shielding light. The surface areas of photoresist zones corresponding to the red, green, and blue colors and a light shielding zone corresponding to the black matrix on the CF substrate directly affect the aperture ratio and the contrast of a liquid crystal display and thus affecting the overall display performance of the liquid crystal display. The aperture ratio is an important parameter of a liquid crystal display panel, which indicates a ratio between an effective light transmitting area and an entire surface area of the liquid crystal display panel. When light emits from a backlight module, the light is not allowed to completely transmit through the liquid crystal display panel. For a TFT substrate, signal wiring of a source drive chip and a gate drive chip of the liquid crystal display panel and the TFT itself, as well as a storage capacitor that stores therein electrical voltage, are sites that are completely non-light-transmitting and thus, light passing through these sites is not controllable by electrical voltage and must be shielded by using the black matrix. For a CF substrate, the primary light transmitting areas include the photoresist zones corresponding to the red, green, and blue sub-pixels, while the black matrix constitutes a non-light-transmitting area for preventing color mixture among red, green, and blue photoresists of each sub-pixels in order to enhance contrast of the panel.

As shown in FIGS. 1 and 2, a CF substrate of a conventional liquid crystal display panel has a surface on which a red sub-pixel 100, a green sub-pixel 200, and a blue sub-pixel 300 are arranged to have the same size. The red sub-pixel 100, the green sub-pixel 200, and the blue sub-pixel 300 are arranged in a row and are arranged sequentially to be side by side to form a distribution of three strips. A black matrix 400 is arranged to surround an outer circumference of each of the sub-pixels. Due to the black matrix 400 occupying a relatively large surface in such a pixel structure, the aperture ratio and contrast of the liquid crystal display panel are relatively low.

Considering the lamination of the TFT substrate and the CF substrate, if signal wiring on the surface of the TFT substrate and the arrangement of all the sub-pixels on the surface of the CF substrate are properly designed, the area of the light shielding zone of the black matrix can be reduced and thus the aperture ratio and light transmittance of the liquid crystal display panel can be increased. With the aperture ratio increased, brightness can be improved and power consumption and expense can be reduced. Further, in the CF substrate, photoresists corresponding to the red, green, and blue sub-pixels have different light transmittances. A similar effect of increasing light transmittance can be achieved if the area of the green sub-pixel that has a large light transmittance is expanded, while the areas of the red and blue sub-pixels that have small light transmittances are reduced.

### SUMMARY OF THE INVENTION

An object of the present invention is to provide a pixel structure that reduces the area occupied by a black matrix and expands the area of a green sub-pixel so as to increase aperture ratio and light transmittance and thus enhance displaying performance.

Another object of the present invention is to provide a liquid crystal display panel, which reduces the area occupied by a black matrix and expands the area of a green sub-pixel so as to increase aperture ratio and light transmittance and thus enhance overall displaying performance of the liquid crystal display panel to make the quality of a displayed image finer and more exquisite.

To achieve the above objects, the present invention first provides a pixel structure, which comprises a plurality of pixel units arranged in an array. Each of the pixel units comprises a red sub-pixel, a green sub-pixel, and a blue sub-pixel, wherein in each of the pixel units, the red sub-pixel, the green sub-pixel, and the blue sub-pixel are arranged in the form of a window sash with the red sub-pixel and the blue sub-pixel arranged in a row in a vertical direction. The green sub-pixel is individually arranged in a row. A surface of the green sub-pixel is greater than or equal to the sum of surface areas of the red sub-pixel and the blue sub-pixel. A black matrix is arranged along outer circumferences of the red sub-pixel, the green sub-pixel, and the blue sub-pixel.

In each of the pixel units, the red sub-pixel, the green sub-pixel, and the blue sub-pixel are all a rectangular shape. A length of green sub-pixel in the vertical direction is greater than or equal to the sum of lengths of the red sub-pixel and the blue sub-pixel in the vertical direction. A width of the green sub-pixel in the horizontal direction is greater than or equal to a width of the red sub-pixel or the blue sub-pixel in the horizontal direction.

The widths of the red sub-pixel and the blue sub-pixel in the horizontal direction are identical and the surface areas of the red sub-pixel and the blue sub-pixel are identical.

In each of the pixel units, the green sub-pixel is located on a leftward portion of the pixel unit and the red sub-pixel and the blue sub-pixel are located on a rightward portion of the pixel unit.

In each of the pixel units, the red sub-pixel is located above the blue sub-pixel.

The present invention also provides a liquid crystal display panel, which comprises a thin-film transistor (TFT) substrate and a color filter (CF) substrate laminated to each other and a liquid crystal layer arranged between the TFT substrate and the CF substrate A surface of the CF substrate comprises a plurality of pixel units is arranged in an array. Each of the pixel units comprises a red sub-pixel, a green sub-pixel, and a blue sub-pixel. In each of the pixel units, the red sub-pixel, the green sub-pixel, and the blue sub-pixel are arranged in the form of a window sash with the red sub-pixel and the blue sub-pixel arranged in a row in a vertical direction. The green sub-pixel is individually arranged in a row. A surface of the green sub-pixel is greater than or equal to the sum of surface areas of the red sub-pixel. A black matrix is arranged along outer circumferences of the blue sub-pixel, the red sub-pixel, the green sub-pixel, and the blue sub-pixel.

A surface of TFT substrate comprises a plurality of scan lines that extends in a horizontal direction, a plurality of data lines that extends in a vertical direction, and a plurality of thin-film transistors Each of the green sub-pixels corresponds to an area delimited by two adjacent ones of the scan lines. Two adjacent data lines that intersect each other. Each of the red sub-pixels and each of the blue sub-pixels correspond to an area delimited by two adjacent scan lines. Two adjacent data lines that intersect each other. One of the thin-film transistors electrically connects the green sub-pixel or the red sub-pixel or the blue sub-pixel to the corresponding scan line and the data line. The data line located between two adjacent pixel units is commonly used by the green sub-pixel of one of the pixel units and the red sub-pixel or the blue sub-pixel of the other one of the pixel units.

In each of the pixel units, the red sub-pixel, the green sub-pixel, and the blue sub-pixel are all a rectangular shape. A length of the green sub-pixel in the vertical direction is greater than or equal to the sum of lengths of the red sub-pixel and the blue sub-pixel in the vertical direction. A width of the green sub-pixel the horizontal direction is greater than or equal to a width of the red sub-pixel or the blue sub-pixel in the horizontal direction.

The widths of the red sub-pixel and the blue sub-pixel in the horizontal direction are identical and the surface areas of the red sub-pixel and the blue sub-pixel are identical.

In each of the pixel units, the green sub-pixel is located on a leftward portion of the pixel unit and the red sub-pixel and the blue sub-pixel are located on a rightward portion of the pixel unit.

In each of the pixel units, the red sub-pixel is located above the blue sub-pixel.

The present invention further provides a pixel structure, which comprises a plurality of pixel units arranged in an array, each of the pixel units comprising a red sub-pixel, a green sub-pixel, and a blue sub-pixel, wherein in each of the pixel units, the red sub-pixel, the green sub-pixel, and the blue sub-pixel are arranged in the form of a window sash with the red sub-pixel and the blue sub-pixel arranged in a row in a vertical direction. The green sub-pixel is individually arranged in a row. A surface area of the green sub-pixel is greater than or equal to the sum of surface areas of the red sub-pixel. A black matrix is arranged along outer circumferences of the blue sub-pixel, the red sub-pixel, the green sub-pixel, and the blue sub-pixel.

In each of the pixel units, the red sub-pixel, the green sub-pixel, and the blue sub-pixel are all a rectangular shape. A length of the green sub-pixel in the vertical direction is greater than or equal to the sum of lengths of the red sub-pixel and the blue sub-pixel in the vertical direction. A width of the green sub-pixel the horizontal direction that is greater than or equal to a width of the red sub-pixel or the blue sub-pixel in the horizontal direction; and

in each of the pixel units, the green sub-pixel is located on a leftward portion of the pixel unit and the red sub-pixel and the blue sub-pixel are located on a rightward portion of the pixel unit.

The widths of the red sub-pixel and the blue sub-pixel in the horizontal direction are identical and the surface areas of the red sub-pixel and the blue sub-pixel are identical.

In each of the pixel units, the red sub-pixel is located above the blue sub-pixel.

The efficacy of the present invention is that the present invention provides a pixel structure and a liquid crystal display panel comprising the pixel structure, wherein each of the pixel units comprises a red sub-pixel, a green sub-pixel, and a blue sub-pixel that are arranged in the form of window sash with the red sub-pixel and the blue sub-pixel arranged in a row in a vertical direction. The green sub-pixel is individually arranged as a row. The green sub-pixel occupies a surface area that is a maximum one so as to, on the one hand, reduce the surface area occupied by a black matrix, expand the area of the light-transmitting zones, and increase aperture ratio and light transmittance and, on the other hand, expand the surface area of the green sub-pixel that has relatively high light transmittance to further increase light transmittance, lower down the cost of backlighting, and improve the entire displaying performance of the liquid crystal display panel. Further, the sub-pixels are arranged in the form of a window sash to help overcome the strip-like display defects caused by the conventional way of arranging sub-pixels in a side-by-side manner and make the quality of a displayed image fines and more exquisite.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing an arrangement of sub-pixels in a single pixel unit of a conventional liquid crystal display panel;

FIG. 2 is a schematic view showing an arrangement of multiple pixel units in a conventional liquid crystal display panel;

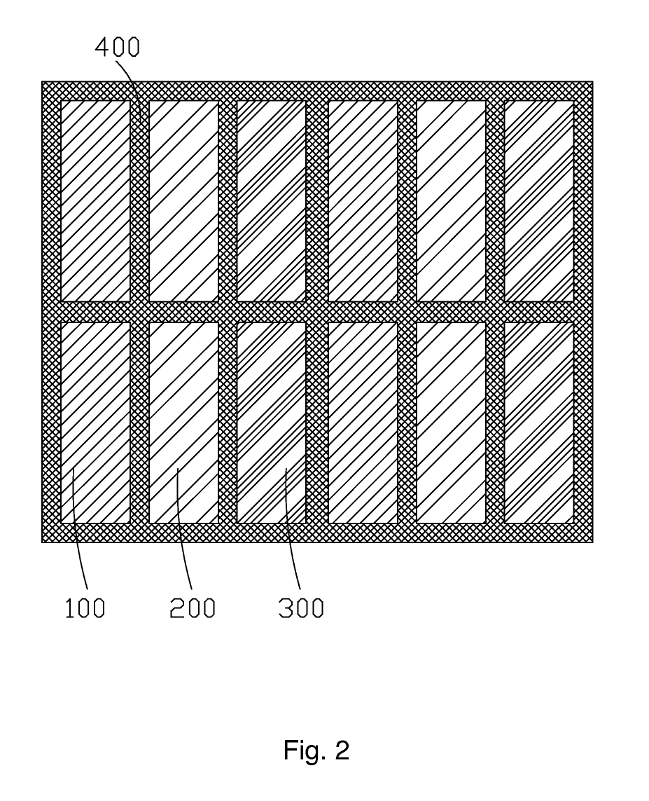

FIG. 3 is a schematic view showing an arrangement of sub-pixels in a single pixel unit of a pixel structure according to the present invention;

FIG. 4 is a schematic view showing an arrangement of multiple pixel units in a pixel structure according to the present invention; and

FIG. 5 is a schematic view showing wiring arrangement on a surface of a thin-film transistor substrate in the liquid crystal display panel according to the present invention that comprises the pixel structure.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

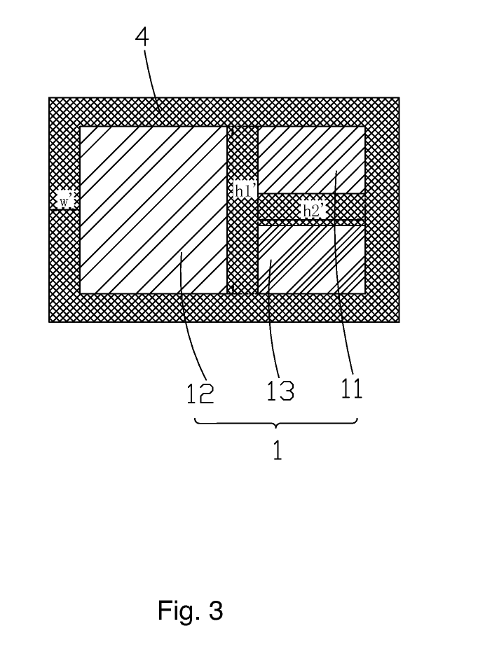

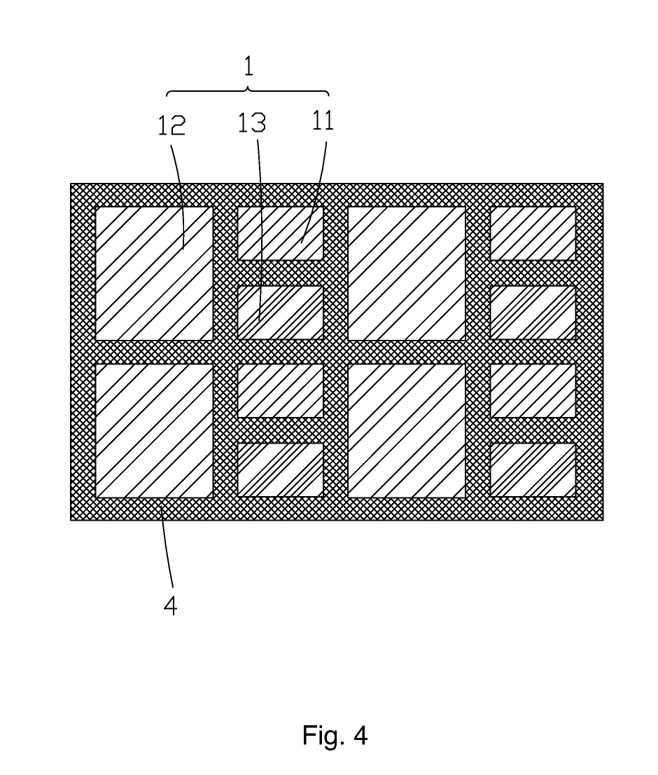

The present invention first provides a pixel structure. As shown in FIGS. 3 and 4, the pixel structure comprises a plurality of pixel units 1 arranged in an array. Each of the pixel units 1 comprises a red sub-pixel 11, a green sub-pixel 12, and a blue sub-pixel 13. In each of the pixel units 1, the red sub-pixel 11, the green sub-pixel 12, and the blue sub-pixel 13 are arranged in the form of a window sash with the red sub-pixel 11. The blue sub-pixel 13 is arranged in a row in a vertical direction. The green sub-pixel 12 is individually arranged in a row. A surface area of the green sub-pixel 12 is greater than or equal to the sum of surface areas of the red sub-pixel 11 and the blue sub-pixel 13. A black matrix 4 is arranged along outer circumferences of the red sub-pixel 11, the green sub-pixel 12, and the blue sub-pixel 13.

Specifically, in each of the pixel units 1, the red sub-pixel 11, the green sub-pixel 12, and the blue sub-pixel 13 are all a rectangular shape. A length of the green sub-pixel 12 in the vertical direction is greater than or equal to the sum of lengths of the red sub-pixel 11 and the blue sub-pixel 13 in the vertical direction. A width of the green sub-pixel 12 in the horizontal direction is greater than or equal to a width of the red sub-pixel 11 or the blue sub-pixel 13 in the horizontal direction. The widths of the red sub-pixel 11 and the blue sub-pixel 13 in the horizontal direction are identical and the surface areas of the red sub-pixel 11 and the blue sub-pixel 13 are identical.

FIGS. 3 and 4 schematically illustrate that in each of the pixel units 1, the green sub-pixel 12 is located one a leftward portion of the pixel unit 1 and the red sub-pixel 11 and the blue sub-pixel 13 are located on a rightward portion of the pixel unit 1. It is apparent that the green sub-pixel 12 may be alternatively located on a rightward portion of the pixel unit 1 and the red sub-pixel 11 and the blue sub-pixel 13 are located on a leftward portion of the pixel unit 1 to similarly achieve a window sash like arrangement of the red sub-pixel 11, the green sub-pixel 12, and the blue sub-pixel 13.

FIGS. 3 and 4 schematically illustrate in each of the pixel units 1, the red sub-pixel 11 is located above the blue sub-pixel 13. It is apparent that the blue sub-pixel 13 may be alternatively located above the red sub-pixel 11 to similarly achieve the arrangement of the red sub-pixel 11 and the blue sub-pixel 13 in a row in the vertical direction.

The pixel structure according to the present invention may reduce the area of a light shielding zone occupied by the black matrix 4, expand the area of the light-transmitting zones, and increase aperture ratio and light transmittance, and may also further increase light transmittance due to the surface area that is occupied by the green sub-pixel that has high light the transmittance is the maximum one.

As shown in FIG. 3, under the assumption that a length of each of the pixel units 1 in the vertical direction and a width in the horizontal direction, both of which are 500 um and the black matrix 4 has a width w′ that is 20 um, with the length of the green sub-pixel 12 in the vertical direction is approximately equal to the sum of the lengths of the red sub-pixel 11 and the blue sub-pixel 13 in the vertical direction and the width of the green sub-pixel 12 in the horizontal direction is equal to widths of the red sub-pixel 11 and the blue sub-pixel 13 in the horizontal direction, excluding the portion of the black matrix 4 that extends along a marginal frame area of the entire pixel unit 1, the total length of the portion of the black matrix 4 that is located in the interior of the pixel unit 1 is:

h1′+h2′=(500−20×2)+(500−20×3)/2=460+220=680 um

In the interior of the entire pixel unit 1, the ratio among the surface areas of the red sub-pixel 11, the green sub-pixel 12, and the blue sub-pixel 13 is approximately 1:2:1. In other words, the green sub-pixel 12 that has relatively high light transmittance occupies a surface area that is the maximum one. Assuming, brightness of the red sub-pixel 11 is 17, brightness of the green sub-pixel 12 is 58, and brightness of the blue sub-pixel 13 is 10, then brightness of the entire pixel unit 1 is:

¼×17+ 2/4×58+¼×10=47.6

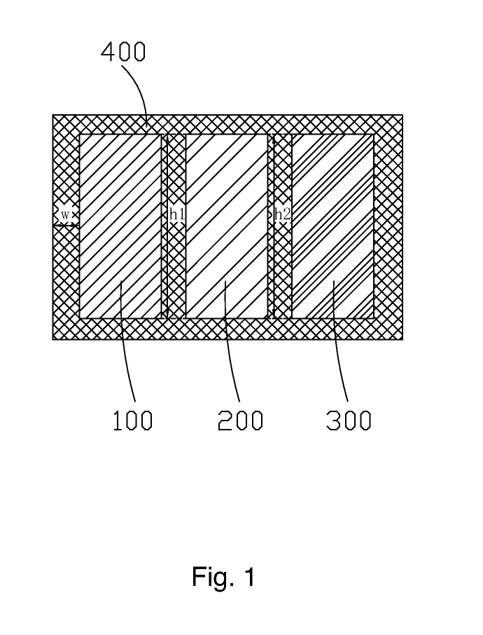

Compared to the conventional arrangement of sub-pixels illustrated in FIG. 1, where similarly assuming each of the conventional pixel units has a length in the vertical direction and a width in the horizontal direction, both of which are 500 um and the black matrix 4 has a width w that is 20 um, since the red sub-pixel 100, the green sub-pixel 200, the blue sub-pixel 300 that are set in an arrangement of three strips having substantially the same size, excluding the portion of the black matrix 400 that extends along a marginal frame area of the entire conventional pixel unit, the total length of the portion of the black matrix 400 that is located in the interior of the conventional pixel unit is:

h1+h2=(500−20×2)+(500−20×2)=460+460=920 um

Compared to the prior art, the pixel structure according to the present invention allows the length of the black matrix to be reduced by:

(920−680)/920=26%

The amount of the length of the black matrix that is reduced is the amount of the aperture ratio that is increased so that an effect of increasing aperture ratio and light transmittance can be achieved.

In the interior of the entire conventional pixel unit, the red sub-pixel 100, the ratio among the surface areas of the green sub-pixel 200, and the blue sub-pixel 300 is 1:1:1. Under the similar assumption that brightness of the red sub-pixel 100 is 17, brightness of the green sub-pixel 200 is 58, and brightness of the blue sub-pixel 300 is 10, then brightness of the entire conventional pixel unit is:

⅓×17+⅓×58+⅓×10=28.3

Compared to the prior art, the pixel structure according to the present invention allows the brightness of a single pixel unit to increase by:

(47.6−28.3)/28.3=62.8%

The amount of the brightness that is increased is the amount of light transmittance that is heightened so that the light transmittance can be further increased.

Further, conventionally, the red sub-pixel 100, the green sub-pixel 200, and the blue sub-pixel 300 are arranged as three side-by-side strips, which would cause strip-like display defects in displaying an image. In the pixel structure according to the present invention, the red sub-pixel 11, the green sub-pixel 12, and the blue sub-pixel 13 are arranged in the form of a window sash that helps improve the strip-like display defects thereby making a displayed image finer and more exquisite.

Based on the pixel structure described above, the present invention further provides a liquid crystal display panel comprising the pixel structure, which comprises a thin-film transistor (TFT) substrate and a color filter (CF) substrate laminated to each other and a liquid crystal layer arranged between the TFT substrate and the CF substrate.

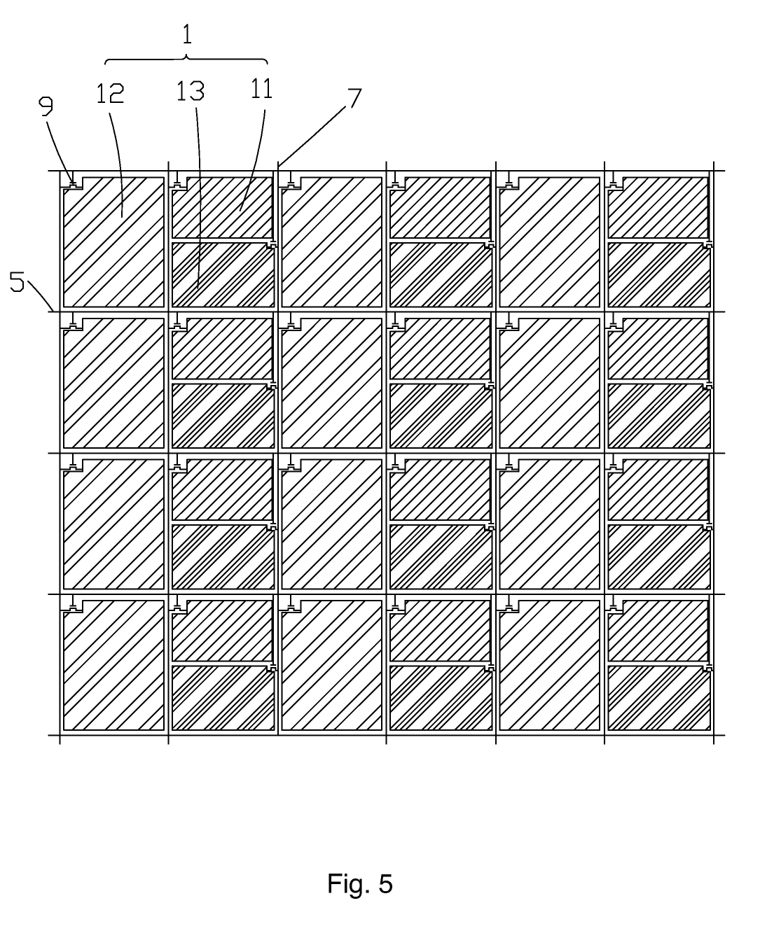

Referring collectively to FIGS. 3-5, the CF substrate has a surface on which a plurality of pixel units 1 is arranged in an array. Each of the pixel units 1 comprises a red sub-pixel 11, a green sub-pixel 12, and a blue sub-pixel 13. In each of the pixel units 1, the red sub-pixel 11, the green sub-pixel 12, and the blue sub-pixel 13 are arranged in the form of a window sash with the red sub-pixel 11. The blue sub-pixel 13 is arranged in a row in a vertical direction. The green sub-pixel 12 is individually arranged in a row. A surface area of the green sub-pixel 12 is greater than or equal to the sum of surface areas of the red sub-pixel 11 and the blue sub-pixel 13. A black matrix 4 is arranged along outer circumferences of the red sub-pixel 11, the green sub-pixel 12, and the blue sub-pixel 13.

The TFT substrate has a surface on which a plurality of scan lines 5 that extend in a horizontal direction, a plurality of data lines 7 that extend in a vertical direction, and a plurality of thin-film transistors 9 are formed. The green sub-pixel 12 corresponds to an area delimited by two adjacent scan lines 5 and two adjacent data lines 7 that intersect each other. The red sub-pixel 11 and the blue sub-pixel 13 correspond to an area delimited by two adjacent scan lines 5 and two adjacent data lines 7 that intersect each other. One thin-film transistor 9 electrically connects the green sub-pixel 12 or the red sub-pixel 11 or the blue sub-pixel 13 to the corresponding scan line 5 and the data line 7. The data line 7 that is located between two adjacent pixel units 1 is commonly used by the green sub-pixel 12 of one of the pixel units 1 and the red sub-pixel 11 (in case the red sub-pixel 11 is located below the blue sub-pixel) or the blue sub-pixel 13 (in case the red sub-pixel 11 is located above the blue sub-pixel) of the other one of the pixel units 1. Such a wiring arrangement is fit to the arrangement of sub-pixels on one surface of the CF substrate and also helps reduce the number of data lines 7 used.

Specifically, in each of the pixel units 1, the red sub-pixel 11, the green sub-pixel 12, and the blue sub-pixel 13 are all a rectangular shape. A length of the green sub-pixel 12 the vertical direction is greater than or equal to the sum of lengths of the red sub-pixel 11 and the blue sub-pixel 13 in the vertical direction. A width of the green sub-pixel 12 n the horizontal direction is greater than or equal to a width of the red sub-pixel 11 or the blue sub-pixel 13 in the horizontal direction. The widths of the red sub-pixel 11 and the blue sub-pixel 13 in the horizontal direction are identical and the surface areas of the red sub-pixel 11 and the blue sub-pixel 13 are identical.

FIGS. 3 and 4 schematically illustrate that in each of the pixel units 1, the green sub-pixel 12 is located on a leftward portion of the pixel unit 1 and the red sub-pixel 11 and the blue sub-pixel 13 are located on a rightward portion of the pixel unit 1. It is apparent that the green sub-pixel 12 may be alternatively located on a rightward portion of the pixel unit 1 and the red sub-pixel 11 and the blue sub-pixel 13 are located on a leftward portion of the pixel unit 1 to similarly achieve a window sash like arrangement of the red sub-pixel 11, the green sub-pixel 12, and the blue sub-pixel 13.

FIGS. 3 and 4 schematically illustrate in each of the pixel units 1, the red sub-pixel 11 is located above the blue sub-pixel 13. It is apparent that the blue sub-pixel 13 may be alternatively located above the red sub-pixel 11 to similarly achieve the arrangement of the red sub-pixel 11 and the blue sub-pixel 13 in a row in the vertical direction.

The liquid crystal display panel according to the present invention can, on the one hand, reduce the area of a light shielding zone occupied by the black matrix 4, expand the area of the light-transmitting zones, and increase aperture ratio and light transmittance, and may, on the other hand, expand the surface area of the green sub-pixel 12 that has relatively high light transmittance so as to further increase light transmittance, lower down the cost of backlighting, and improve the entire displaying performance of the liquid crystal display panel. Further, the red sub-pixel 11, the green sub-pixel 12, and the blue sub-pixel 13 that are arranged in the form of a window sash help overcome the strip-like display defects caused by the conventional way of arranging sub-pixels in a side-by-side manner and make the quality of a displayed image fines and more exquisite.

In summary, the present invention provides a pixel structure and a liquid crystal display panel comprising the pixel structure, wherein each of the pixel units comprises a red sub-pixel, a green sub-pixel, and a blue sub-pixel that are arranged in the form of window sash with the red sub-pixel and the blue sub-pixel arranged in a row in a vertical direction. The green sub-pixel is individually arranged as a row. The green sub-pixel occupies a surface area that is a maximum one so as to, on the one hand, reduce the surface area occupied by a black matrix, expand the area of the light-transmitting zones, and increase aperture ratio and light transmittance and, on the other hand, expand the surface area of the green sub-pixel that has relatively high light transmittance to further increase light transmittance, lower down the cost of backlighting, and improve the entire displaying performance of the liquid crystal display panel. Further, the sub-pixels are arranged in the form of a window sash to help overcome the strip-like display defects caused by the conventional way of arranging sub-pixels in a side-by-side manner and make the quality of a displayed image fines and more exquisite.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A pixel structure, comprising a plurality of pixel units arranged in an array, wherein each of the pixel units comprises a red sub-pixel, a green sub-pixel, and a blue sub-pixel; wherein in each of the pixel units, the red sub-pixel, the green sub-pixel, and the blue sub-pixel are arranged in the form of a window sash with the red sub-pixel and the blue sub-pixel arranged in a row in a vertical direction; and the green sub-pixel is individually arranged in a row; and a surface area of the green sub-pixel is greater than or equal to the sum of surface areas of the red sub-pixel and the blue sub-pixel; wherein a black matrix is arranged along outer circumferences of the red sub-pixel, the green sub-pixel, and the blue sub-pixel.

2. The pixel structure as claimed in claim 1, wherein in each of the pixel units, the red sub-pixel, the green sub-pixel, and the blue sub-pixel are all a rectangular shape; wherein a length of the green sub-pixel in the vertical direction is greater than or equal to the sum of lengths of the red sub-pixel and the blue sub-pixel in the vertical direction; wherein a width of the green sub-pixel in the horizontal direction is greater than or equal to a width of the red sub-pixel or the blue sub-pixel in the horizontal direction.

3. The pixel structure as claimed in claim 2, wherein the widths of the red sub-pixel and the blue sub-pixel in the horizontal direction are identical and the surface areas of the red sub-pixel and the blue sub-pixel are identical.

4. The pixel structure as claimed in claim 1, wherein in each of the pixel units, the green sub-pixel is located on a leftward portion of the pixel unit and the red sub-pixel and the blue sub-pixel are located on a rightward portion of the pixel unit.

5. The pixel structure as claimed in claim 4, wherein in each of the pixel units, the red sub-pixel is located above the blue sub-pixel.

6. A liquid crystal display panel, comprising a thin-film transistor (TFT) substrate and a color filter (CF) substrate laminated to each other and a liquid crystal layer arranged between the TFT substrate and the CF substrate; wherein the CF substrate has a surface on which a plurality of pixel units is arranged in an array; wherein each of the pixel units comprises a red sub-pixel, a green sub-pixel, and a blue sub-pixel; wherein in each of the pixel units, the red sub-pixel, the green sub-pixel, and the blue sub-pixel are arranged in the form of a window sash with the red sub-pixel and the blue sub-pixel arranged in a row in a vertical direction; the green sub-pixel is individually arranged in a row; and a surface area of the green sub-pixel is greater than or equal to the sum of surface areas of the red sub-pixel and the blue sub-pixel, wherein a black matrix is arranged along outer circumferences of the red sub-pixel, the green sub-pixel, and the blue sub-pixel; and
wherein the TFT substrate has a surface on which a plurality of scan lines that extends in a horizontal direction, a plurality of data lines that extends in a vertical direction, and a plurality of thin-film transistors are formed, wherein each of the green sub-pixels corresponds to an area delimited by two adjacent scan lines and two adjacent data lines that intersect each other, and wherein each of the red sub-pixels and each of the blue sub-pixels correspond to an area delimited by two adjacent scan lines and two adjacent data lines that intersect each other wherein one of the thin-film transistors electrically connects the green sub-pixel or the red sub-pixel or the blue sub-pixel to the corresponding scan line and the data line, and wherein the data line that is located between two adjacent pixel units is commonly used by the green sub-pixel of one of the pixel units and the red sub-pixel or the blue sub-pixel of the other one of the pixel units.

7. The liquid crystal display panel as claimed in claim 6, wherein in each of the pixel units, the red sub-pixel, the green sub-pixel, and the blue sub-pixel are all a rectangular shape; wherein a length of the green sub-pixel in the vertical direction is greater than or equal to the sum of lengths of the red sub-pixel and the blue sub-pixel in the vertical direction; and wherein a width of the green sub-pixel in the horizontal direction is greater than or equal to a width of the red sub-pixel or the blue sub-pixel in the horizontal direction.

8. The liquid crystal display panel as claimed in claim 7, wherein the widths of the red sub-pixel and the blue sub-pixel in the horizontal direction are identical and the surface areas of the red sub-pixel and the blue sub-pixel are identical.

9. The liquid crystal display panel as claimed in claim 6, wherein in each of the pixel units, the green sub-pixel is located on a leftward portion of the pixel unit and the red sub-pixel and the blue sub-pixel are located on a rightward portion of the pixel unit.

10. The liquid crystal display panel as claimed in claim 9, wherein in each of the pixel units, the red sub-pixel is located above the blue sub-pixel.

11. A pixel structure, comprising a plurality of pixel units arranged in an array, wherein each of the pixel units comprises a red sub-pixel, a green sub-pixel, and a blue sub-pixel; wherein in each of the pixel units, the red sub-pixel, the green sub-pixel, and the blue sub-pixel are arranged in the form of a window sash with the red sub-pixel and the blue sub-pixel arranged in a row in a vertical direction and wherein the green sub-pixel is individually arranged in a row; wherein a surface of the green sub-pixel is greater than or equal to the sum of surface areas of the red sub-pixel and the blue sub-pixel; and wherein a black matrix is arranged along outer circumferences of the red sub-pixel, the green sub-pixel, and the blue sub-pixel;
wherein in each of the pixel units, the red sub-pixel, the green sub-pixel, and the blue sub-pixel are all a rectangular shape; wherein a length of the green sub-pixel in the vertical direction is greater than or equal to the sum of lengths of the red sub-pixel and the blue sub-pixel in the vertical direction; and wherein a width of the green sub-pixel h in the horizontal direction is greater than or equal to a width of the red sub-pixel or the blue sub-pixel in the horizontal direction; and
wherein in each of the pixel units, the green sub-pixel is located on a leftward portion of the pixel unit and the red sub-pixel and the blue sub-pixel are located on a rightward portion of the pixel unit.

12. The pixel structure as claimed in claim 11, wherein the widths of the red sub-pixel and the blue sub-pixel in the horizontal direction are identical and the surface areas of the red sub-pixel and the blue sub-pixel are identical.

13. The pixel structure as claimed in claim 11, wherein in each of the pixel units, the red sub-pixel is located above the blue sub-pixel.
